(19) United States
(12) Patent Application Publication
(10) Pub. No.: US 2010/0302991 A1
(43) Pub. Date: Dec. 2, 2010

(54) SYSTEM AND PROCESS FOR TRANSMIT DIVERSITY IN SATELLITE PHONES

(75) Inventors: Ahmad Jalali, Rancho Santa Fe, CA (US); Harris S. Simon, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/749,686

(22) Filed: Mar. 30, 2010

Related U.S. Application Data
(60) Provisional application No. 61/183,450, filed on Jun. 2, 2009.

(51) Int. Cl. H04W 88/02; H04L 1/02; H04B 1/02

(52) U.S. Cl. 370/313; 375/267; 455/101

(57) ABSTRACT

An apparatus and method inexpensively implements spatial diversity in a wireless terminal for use in a satellite communication system. A single transmit chain is coupled to a plurality of antennas through a switch for sequentially selecting each of the antennas during corresponding sub-frames of a data frame. Here, each sub-frame is adapted for transmission of a respective portion of an encoded information packet, encoded such that the entire information packet is recoverable from any one of the sub-frames.

### CLAIM OF PRIORITY UNDER 35 U.S.C. §119

The present application for patent claims priority to Provisional Application No. 61/183,450 entitled “Transmitter Antenna Diversity Scheme for Satellite Phones” filed Jun. 2, 2009, and assigned to the assignee hereof and hereby expressly incorporated by reference herein.

### BACKGROUND

1. Field

The instant disclosure relates generally to wireless communications, and more particularly, to antenna diversity techniques that may be applied to satellite communication systems.

2. Background

Recently, geostationary satellites with very large antennas are being built and deployed. Because the gain of these satellites' antennas is quite large, it is becoming feasible to make calls using these satellites with small mobile handsets with small/built in antennas. In previous satellite systems, the satellite phones generally required a larger antenna to close the link over the satellite.

However, because of the large distance to the satellite and the small transmit power from the phone, it is particularly important to improve the reverse link, i.e., the link in the direction from the handset to the satellite. Because the small antennas in the handset generally have gain in all directions, they equally provide a main (line of sight) signal as well as a signal that bounces from the ground.

Channel fading is a ubiquitous and fundamental characteristic of wireless communication systems. Fading deteriorates the link reliability of the wireless channel, thereby reducing system capacity and/or degrading user service experience. In particular, in satellite phone applications utilizing an omnidirectional antenna for transmission, the problem of multipath fading, wherein the line-of-sight component of the transmitted signal directed toward the satellite and the component of the transmitted signal that bounces off the ground may destructively interfere with one another, causing an intermittent deep fade at the satellite receiver.

Diversity is a well-known principle that effectively combats wireless channel fading. If two spatially separated antennas are used for transmission from the handset, then it is very likely that at least one of the antennas is not in a fade, and the data may be decoded correctly using the signal from the antenna with the stronger signal.

FIG. 1 illustrates a simplified diagram of a transmitter 100 in a prior art wireless system equipped with multiple antennas (transmit antenna 1 102 and transmit antenna N 102′) that may exploit transmit diversity. In the transmitter 100 illustrated in FIG. 1, the same information-bearing signal, source signal 104, is first split and pre-processed by splitter pre-processor 106 to generate multiple transmit signals (108, 108′), which are correlated with each other. These multiple transmit signals (108, 108′) are then individually passed through separate transmit chains including digital signal processing blocks (110, 110′), digital-to-analog conversion blocks (112, 112′), analog signal processing blocks (114, 114′) and transmitted with multiple antennas (102, 102′), respectively.

Transmit diversity refers to the realization of diversity gain by sending multiple, correlated signals over a channel from the transmitter. Typically, transmit diversity techniques make use of multiple transmit antennas to transmit these correlated signals. For example, a data stream to be transmitted may have error correction codes added, and then be split into multiple streams, each stream being simultaneously sent on a respective one of the antennas. Here, if the error correction code is powerful enough, then, even if one or more of the plurality of antennas is lost, the encoded data may still be recovered.

These conventional transmit diversity schemes may be undesirable in a small, inexpensive mobile device. That is, the requirement of known transmit diversity techniques to use multiple transmitter chains, each of which normally includes both digital and analog signal processing blocks, is difficult to implement when the amount of physical space in such a device may be very limited. Furthermore, the cost of doubling the transmit chain can be prohibitive in many applications.

In view of the above discussion, there is a need for improved methods and apparatus of achieving transmit diversity in wireless communications systems.

### SUMMARY

An apparatus and method inexpensively implements spatial diversity in a wireless terminal for use in a satellite communication system. In an aspect of the disclosure, a method of wireless communication includes transmitting, from a first antenna, a first sub-packet during a first sub-frame, and transmitting, from a second antenna spatially separated from the first antenna, a second sub-packet during a second sub-frame after the first sub-frame. Here, the first sub-packet and the second sub-packet are portions of an encoded packet, encoded such that user information corresponding to the entire packet is independently recoverable from the first sub-packet or the second sub-packet.

In another aspect of the disclosure, an apparatus for wireless communication includes means for transmitting, from a first antenna, a first sub-packet during a first sub-frame, and means for transmitting, from a second antenna spatially separated from the first antenna, a second sub-packet during a second sub-frame after the first sub-frame. Here, the first sub-packet and the second sub-packet are portions of an encoded packet such that user information corresponding to the entire packet is recoverable from either one of the first sub-packet or the second sub-packet.

In another aspect of the disclosure, a computer program product includes a computer-readable medium having code for transmitting, from a first antenna, a first sub-packet during a first sub-frame, and code for transmitting, from a second antenna spatially separated from the first antenna, a second sub-packet during a second sub-frame after the first sub-frame. Here, the first sub-packet and the second sub-packet are portions of an encoded packet such that user information corresponding to the entire packet is recoverable from either one of the first sub-packet or the second sub-packet.

In another aspect of the disclosure, an apparatus for wireless communication includes at least one processor and a memory coupled to the at least one processor, wherein the at least one processor is configured to transmit, from a first antenna, a first sub-packet during a first sub-frame, and to transmit, from a second antenna spatially separated from the first antenna, a second sub-packet during a second sub-frame after the first sub-frame. Here, the first sub-packet and the second sub-packet are portions of an encoded packet such that user information corresponding to the entire packet is recoverable from either one of the first sub-packet or the second sub-packet.

In another aspect of the disclosure, a transmitter module includes a plurality of spatially separated antennas and a switch coupled to each of the plurality of spatially separated antennas, the switch for sequentially selecting one of the plurality of spatially separated antennas during a corresponding sub-frame of a data frame. Here, each sub-frame is adapted for transmission of a respective portion of an encoded information packet, encoded such that the entire information packet is recoverable from any one of the sub-frames.

### BRIEF DESCRIPTION OF THE DRAWINGS

FIG. 1 is a block diagram conceptually illustrating a transmitter for transmit diversity according to the prior art.

FIG. 2 is a diagram illustrating an example of a hardware implementation for an apparatus employing a processing system.

FIG. 3 is a block diagram illustrating a satellite in communication with a wireless terminal and a gateway in a satellite communication system.

FIG. 4 is a block diagram conceptually illustrating a portion of a transmitter for transmit diversity according to an aspect of the disclosure.

FIG. 5 is a flow chart conceptually illustrating a process of transmitting a frame from a wireless terminal according to an aspect of the disclosure.

FIG. 6 is a timing diagram schematically illustrating a frame according to an aspect of the disclosure.

FIG. 7 is a flow chart conceptually illustrating a process of changing a transmission characteristic according to an aspect of the disclosure.

FIGS. 8A and 8B are flow charts conceptually illustrating two processes for determining whether an antenna is blocked according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

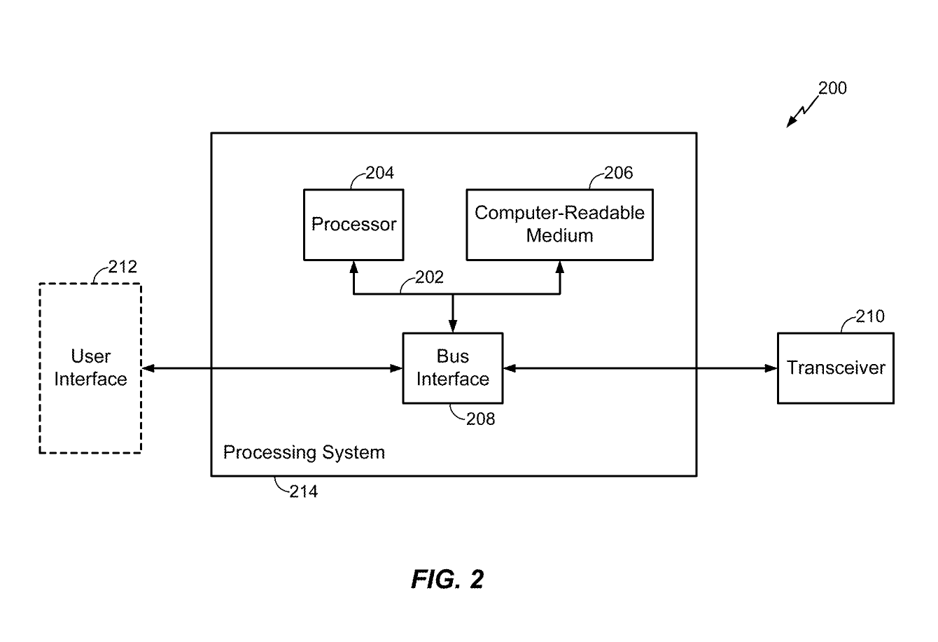

FIG. 2 is a conceptual diagram illustrating an example of a hardware implementation for an apparatus 200 employing a processing system 214. In this example, the processing system 214 may be implemented with a bus architecture, represented generally by the bus 202. The bus 202 may include any number of interconnecting buses and bridges depending on the specific application of the processing system 214 and the overall design constraints. The bus 202 links together various circuits including one or more processors, represented generally by the processor 204, and computer-readable media, represented generally by the computer-readable medium 206. The bus 202 may also link various other circuits such as timing sources, peripherals, voltage regulators, and power management circuits, which are well known in the art, and therefore, will not be described any further. A bus interface 208 provides an interface between the bus 202 and a transceiver 210. The transceiver 210 provides a means for communicating with various other apparatus over a transmission medium. Depending upon the nature of the apparatus, a user interface 212 (e.g., keypad, display, speaker, microphone, joystick) may also be provided.

The processor 204 is responsible for managing the bus 202 and general processing, including the execution of software stored on the computer-readable medium 206. The software, when executed by the processor 204, causes the processing system 214 to perform the various functions described infra for any particular apparatus. The computer-readable medium 206 may also be used for storing data that is manipulated by the processor 204 when executing software.

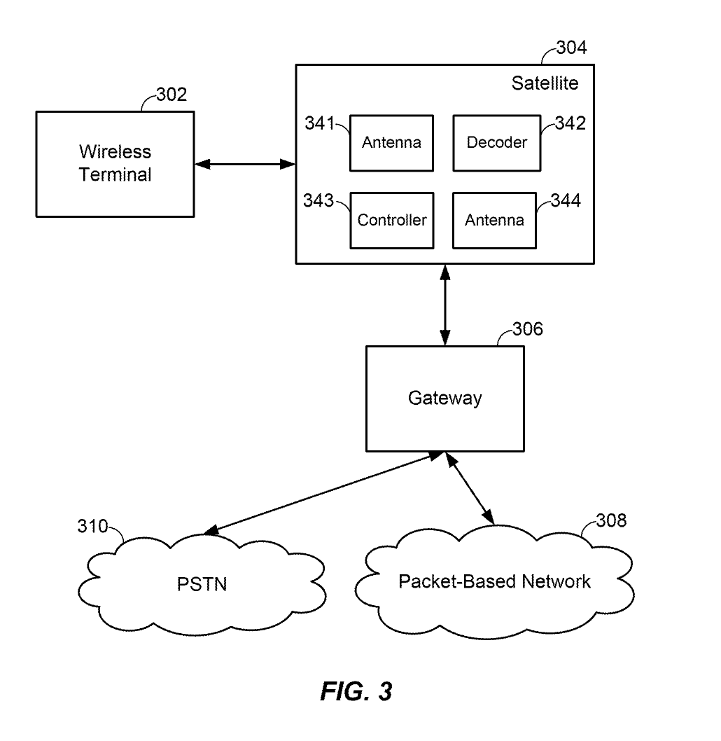

FIG. 3 is a block diagram conceptually illustrating an example of a satellite telecommunications system. The various concepts presented throughout this disclosure may be implemented across a broad variety of wireless telecommunication systems, network architectures, and communication standards, including cellular communications that utilize cellular base stations (e.g., a Node B in a UMTS network), and are not intended to be limited to satellite communications systems. By way of example and without limitation, the aspects of the present disclosure illustrated in FIG. 3 are presented with reference to a satellite telecommunications system including a wireless terminal 302, a satellite 304, a gateway 306, and a packet-based network 308. The wireless terminal 302 may be a dedicated satellite phone or other mobile or fixed equipment configured for communication with one or more satellites 304. In another aspect of the disclosure, the wireless terminal may be a multimode device, such as a cellular phone configured for communication over a cellular radio access technology such as UMTS, CDMA2000, 3GPP LTE, etc., in addition to communication with the one or more satellites 304. Satellite 304 may be any suitable satellite for communication with the wireless terminal 302 and gateway 306. For example, the satellite 304 may be a geostationary satellite, a low-earth orbit satellite, or any other suitable orbit, and may have one or more radio antennas 341 for communication with any number of wireless terminals 302 over any suitable communication protocol, and a decoder 342 for decoding signals received from the wireless terminal 302. Satellite 304 may further include an interface, for example, a high-bandwidth, high-power interface, for communication with gateway 306. The interface may include a controller 343 and antenna 344. In various aspects of the disclosure, portions of the satellite 304 may be implemented as a processing system such as the processing system illustrated in FIG. 2, or as application specific circuit components suitable for use in orbit.

The gateway 306 may be a ground-based unit providing an interface between the satellite 304 and a packet-based network 308, such as the Internet. In an aspect of the disclosure, gateway 306 may include any number of sub-components, including satellites, ground-based modules, etc. In another aspect of the disclosure, gateway 306 provides an interface to a circuit-switched network, such as a public switched telephone network (PSTN) 310.

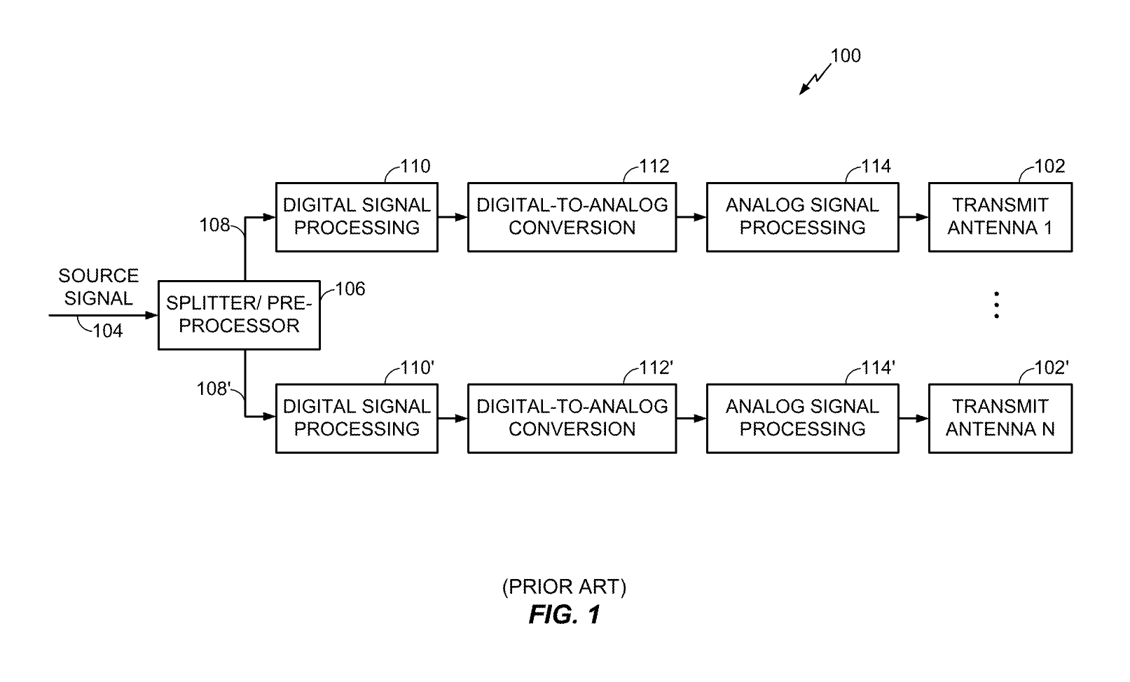

As discussed above with respect to FIG. 1, although the principle of transmit diversity may help to improve the reliability of a wireless link, the use of multiple transmit chains increases the cost and complexity of the transmitter. Typically, in a wireless communications system, there are many wireless terminals for each base station or satellite deployed. The wireless terminals may be, e.g., consumer owned and operated portable battery powered mobile devices such as cell phones or multimode cellular data communication devices. The increased cost and complexity are particularly important considerations at the wireless terminal, e.g., mobile node, side. Various aspects and features of the present disclosure are directed to wireless systems equipped with multiple antennas that can achieve diversity with a minimal increase in cost and/or complexity.

Various aspects of providing transmit diversity, in accordance with the present invention, shall now be described. In accordance with various aspects of the disclosure, transmit diversity can be achieved in a wireless communication system by employing a single transmit chain and by switching between multiple transmit antennas.

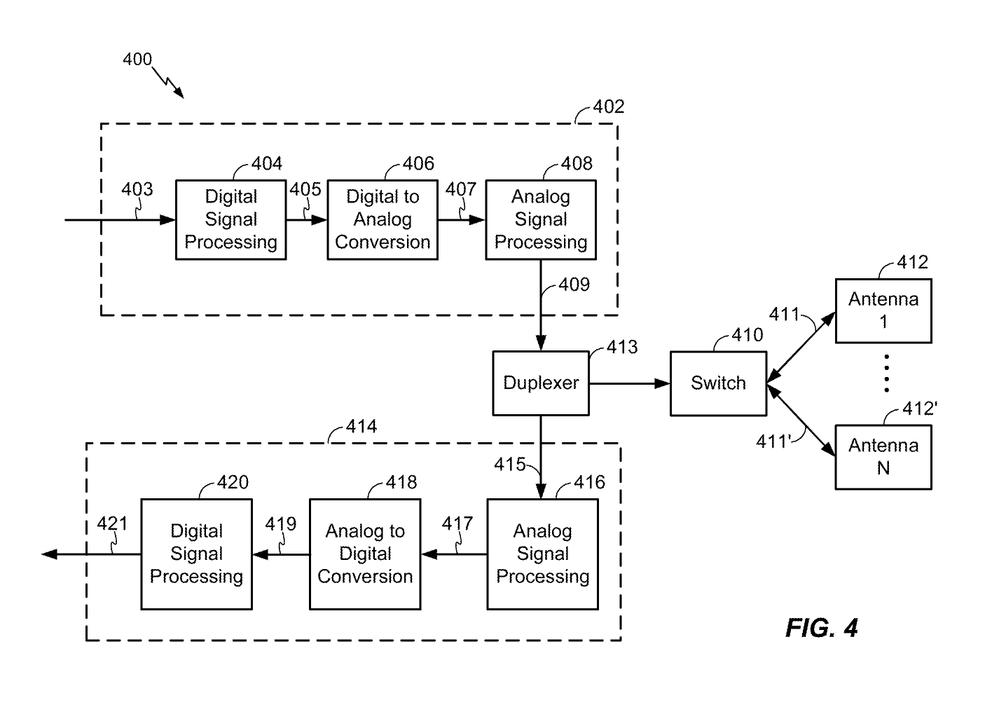

FIG. 4 is a block diagram of a portion of an apparatus 400 including an exemplary transmit chain 402 and receive chain 414 in accordance with the present disclosure. The exemplary transmit chain 402 includes a digital signal processing block 404, a digital-to-analog conversion block 406, and an analog signal processing block 408. A user data stream 403 (e.g., one or more packets) from a data source (not shown) is input to the digital signal processing block 404. The digital signal processing block 404 encompasses and performs digital domain signal processing functions, such as encoding, modulation and digital filtering. The digital signal processing block 404 typically includes a baseband digital chain. An output digital signal 405 from the digital signal processing block 404 is input to the digital-to-analog conversion block 406. The digital-to-analog conversion block 406 converts digital signal 405 to analog signal 407, which becomes the input to the analog signal processing block 408. The analog signal processing block 408 encompasses and performs analog domain signal processing functions, such as up-conversion to carrier frequency, analog filtering and power amplification. The analog signal processing block 408 typically includes a baseband analog chain and RF analog chain. The output 409 of the analog signal processing block 408 is then routed via a duplexer 413 and a switch 410 as output signal (411 or 411′) and then transmitted through one of a plurality of spatially separated antennas (antenna 1 412 to antenna N 412′), respectively. The duplexer 413 prevents a relatively powerful signal from the transmit chain 402 from damaging the receive chain 414. The switch 410 determines which antenna (412, 412′) to be used at any given time. From time to time, the switch 410 chooses to use different antennas (412, 412′), and directs the output 409 of the analog signal processing block 408 to the chosen antenna (412 or 412′). In various aspects of the disclosure, the switch 410 may be an RF switch, a microwave switch, or an optical switch, including any suitable components such as discrete or integrated FET and/or bipolar transistor switches; and further, may be configured as a single-pole double-throw, transfer (double-pole double-throw), or multiposition switch. Moreover, the switch 410 may be single-directional or bi-directional.

The exemplary receive chain 414 includes an analog signal processing block 416, an analog-to-digital conversion block 418, and a digital signal processing block 420. The switch 410 determines which antenna (812, 812′) to be used at any given time. For time to time, the switch 410 chooses to use different antennas, and directs signal (411, 411′) from the chosen antenna (412, 412′), respectively, to the input 415 of the analog signal processing block 808 via the duplexer 413. The analog signal processing block 416 encompasses and performs analog domain signal processing functions, analog filtering, low-noise amplification, and down-conversion to baseband. The analog signal processing block 416 typically includes baseband analog chain and a RF analog chain. The output of the analog signal processing block 416 is signal 417. The analog-to-digital-conversion block 418 converts the output 417 of the analog signal processing block 416 to a digital signal 419, which becomes the input of the digital signal processing block 420. The digital signal processing block 420 encompasses and performs digital domain signal processing functions, such as digital filtering, decoding, and demodulation. The digital signal processing block 420 typically includes a baseband digital chain. The output of digital signal processing block 420 is digital signal 421, which is typically sent to a data sink (not shown).

In various aspects of the disclosure, an apparatus may include more than one switch 410, for example, separate switches for the transmit chain 402 and receive chain 414. In another aspect of the disclosure, an apparatus may include any suitable number of spatially separated antennas 412, 412′, such as two or more antennas. Here, spatially separated may refer to antennas that occupy different locations in space so as to enable spatial diversity. The individual antennas may have the same characteristics as one another or may have different RF characteristics.

In various aspects of the disclosure, the switch 410 may sequentially select each of the antennas. Here, sequentially selecting each of the plurality of antennas refers to selecting each one of the plurality of antennas in turn, and does not necessarily refer to any particular order of antennas.

In an aspect of the disclosure, all or a portion of the transmit chain 402 and/or receive chain 414 may be implemented by the processing system 214 illustrated in FIG. 2. In another aspect of the disclosure, the processing system 214 may provide the data source and/or data sink that provides data 403 into the transmit chain 402 and receives data 421 from the receive chain 414. The processing system 214 may further provide control for various blocks in the block diagram 400.

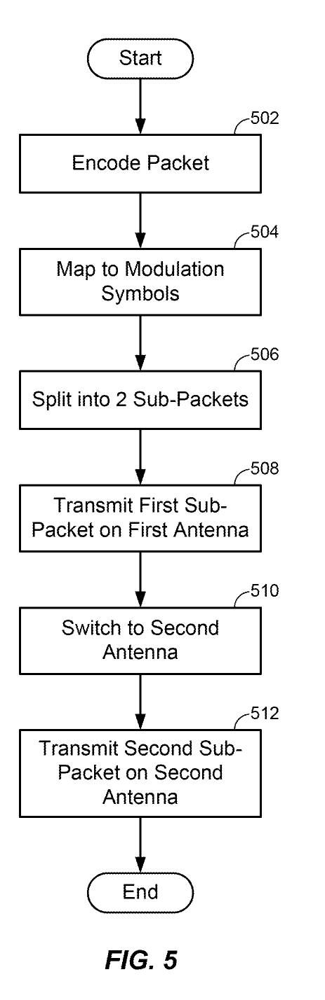

FIG. 5 is a flow chart illustrating a process of transmitting user data by implementing orthogonal transmit diversity from the wireless terminal. In one example, the process of FIG. 5 may be implemented by the apparatus illustrated in FIG. 4. In block 502, the process encodes a packet of data. For example, a packet of data may be essentially any quantity of data in a digital form, and may represent any type of information such as voice, video, documents, files, databases, etc., from a data source or processing system 214 (see FIG. 2). For example, the packet may be a portion of a data stream, or a concatenation of a plurality of data streams from another module, and may be separated into sub-packets or concatenated into larger packets. Encoding the packet may include incorporating a redundant error correction code into the packet by utilizing a code such as a Reed-Solomon code, convolutional code, turbo code, etc., such that the entire data stream may be recovered even if portions of the data stream are lost by the receiver. In one example, a turbo code having a code rate of ½ or less (i.e., where the fraction represents the fraction of the total that is actual data, e.g., a code rate of ⅓ representing 1 bit of data for every 2 bits of redundancy) is used, such that the entire data stream may be recovered even if half of the data stream is lost.

In block 504, the process maps the encoded packet to a set of modulation symbols. The modulation symbols utilized herein may take essentially any suitable format, for example, m-ary phase shift keying (mPSK), or quadrature amplitude modulation (QAM), etc. In block 506, the resulting encoded and modulated packet is split into two sub-packets. In some aspects of the disclosure, the packet may be split into any number of sub-packets, the number of sub-packets generally corresponding to the number of antennas, although this is not necessarily the case.

In block 508, the process transmits the first sub-packet on a first antenna. In one example utilizing the apparatus illustrated in FIG. 4, the transmit chain 402 transmits a signal by way of the analog signal processing block 408, which is sent through the duplexer 413 and the switch 410 to a respective one of the antennas 412, 412′. Following the transmission of the first sub-packet, in block 510 the process switches to the second antenna, and in block 512 the process transmits the second sub-packet on the second antenna.

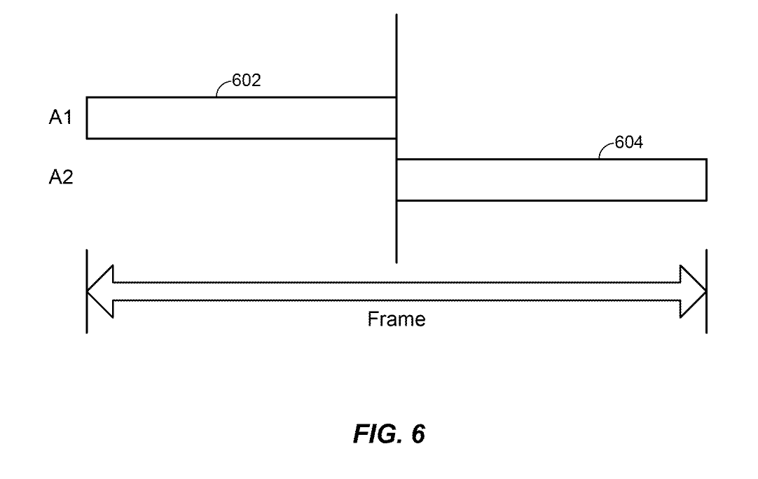

FIG. 6 illustrates a data frame having two sub-frames, resulting from the process according to the flow chart of FIG. 5. That is, the sub-packets of the packet each correspond to a respective one of the sub-frames 602, 604. In FIG. 6, the first sub-frame 602 is transmitted by the first antenna A1, and the second sub-frame 604 is transmitted by the second antenna A2. As mentioned above, in an aspect of the disclosure, the encoded and modulated packet is split into two sub-packets, such that each of the sub-frames 602, 604 is a transmission of one of the two sub-packets. Further, in an aspect of the disclosure, a robust forward error correction code may be utilized having a code rate of ½ or less, such that at least half the data symbols are transmitted on the stronger antenna. Thus, recovery of the transmission in the first sub-frame 602 alone should enable recovery of the entire original user data prior to encoding. Similarly, recovery of the transmission in the second sub-frame 604 alone should enable recovery of the entire original user data. In this way, in the event that one of the two antennas is in a fade, or is blocked, the entire user data may still be recovered in a robust manner because the stronger of the two antennas is likely to be received and recoverable.

Various aspects of the disclosure may utilize frames having more than the two sub-frames illustrated in FIG. 6. In general, each of the sub-frames corresponds to a transmission from a respective one of the antennas, in sequence, switched by a switch from a single transmit chain. In some aspects of the disclosure, the error correction coding is such that the entire packet transmitted in the frame is recoverable from any one of the sub-frames. Thus, in this aspect, for N sub-frames, a coding rate is less than or equal to 1/N. In another aspect of the disclosure, the error correction coding is such that the entire packet transmitted in the frame is recoverable when any one of the sub-frames is dropped, for example, when one of the antennas is blocked or in a fade. Thus, in this aspect, for N sub-frames, a coding rate is less than or equal to (N−1)/N.

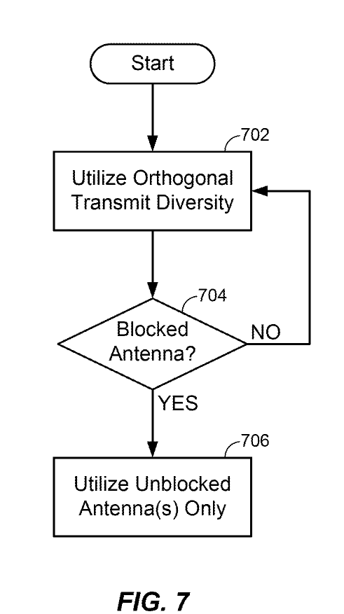

In another aspect of the disclosure, the apparatus may select one antenna for transmission of the user data based on a determination that the other antenna is blocked. FIG. 7 is a flow chart illustrating a process according to this aspect of the disclosure. In block 702, the process utilizes the orthogonal transmit diversity scheme as described above with reference to FIG. 5, that is, splitting the encoded and modulated packet between the two antennas in two sub-frames, for example. In block 704, the process determines whether one of the antennas is blocked, for example, by a user's hand. If the process determines that one of the antennas is blocked, then in block 706, the process utilizes only the unblocked antenna to transmit the entire packet, utilizing any suitable encoding/modulation scheme. In an aspect of the disclosure, both sub-frames 602 and 604 may be transmitted in sequence from the unblocked antenna, without switching the switch 410. In another aspect of the disclosure, in block 706, a different encoding and/or modulation may be utilized as suitable for the transmission over a single antenna as opposed to the transmission in block 702. If the process determines in block 704 that neither antenna is blocked, then the process returns to block 702, continuing the transmission as already described.

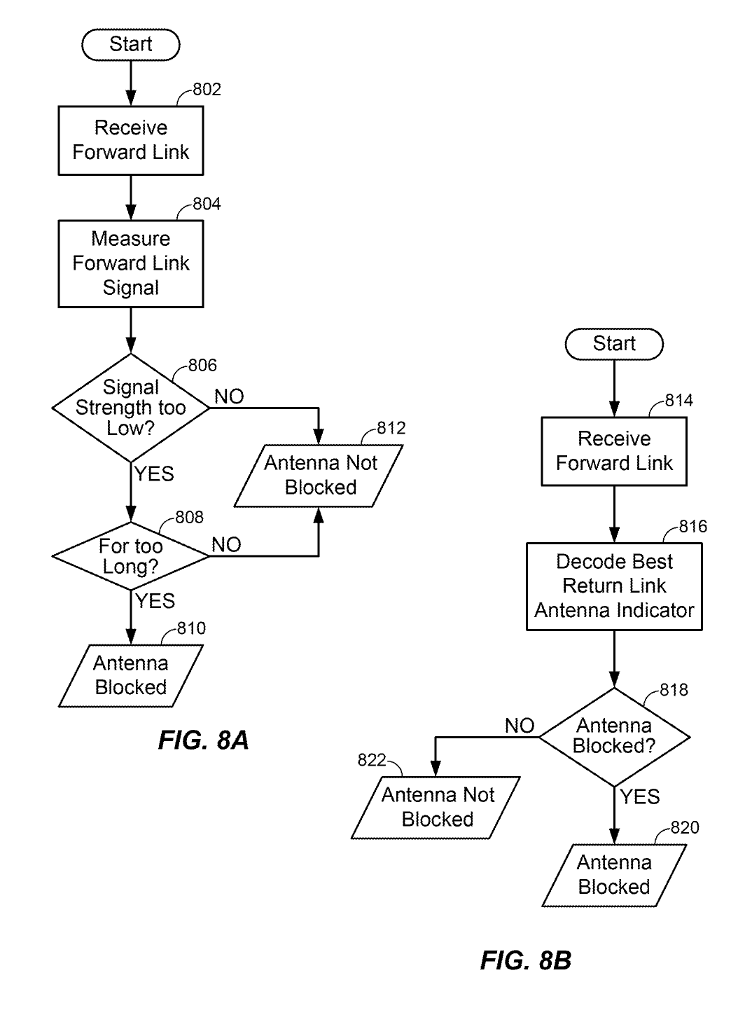

FIGS. 8A and 8B illustrate two exemplary processes for determining whether one of the antennas is blocked. In one example, the process illustrated in either of FIG. 8A or 8B may be utilized in block 704 of FIG. 7. In another example, a process may utilize both processes in FIGS. 8A and 8B, and the determination that one of the antennas is blocked may be made if either one of the processes illustrated therein determines that this is the case.

In FIG. 8A, the received signal strength may be measured on both of the antennas in receive mode, and the antenna that receives a signal having a most suitable characteristic, such as a signal power or a signal-to-interference ratio, etc., may be chosen to transmit on the return link. Those skilled in the art may realize that the fading on the forward link is generally uncorrelated with the fading on the return link. That is, in the case of multipath fading, the return link, which generally uses a different frequency than the forward link in a frequency division duplex system (e.g., separated by 100 MHz), may be suitably received even though the forward link is in a deep fade at that instant. Thus, making rapid decisions for antenna selection on the return link based on signal characteristics of the forward link may not result in improved signal robustness. However, this scheme may be useful for cases where one of the antennas in the wireless terminal is blocked, for example, by the user's hand. In this case, the blockage of one of the antennas may take place for a relatively longer period of time, such as when a user is holding a mobile phone in a relatively fixed position during a conversation.

Thus, in block 802, the process receives the forward link from the satellite or base station. Here, referring to FIG. 4, the duplexer 413 may couple one of the antennas 412, 412′, according to the switch 410, with the receive chain 414. The switch 410 may switch between the two antennas 412, 412′ such that the forward signal may be received on each of the antennas. In block 804, the process measures a characteristic of the forward link signal. The characteristic of the forward link signal may be a signal strength, a signal-to-noise ratio, or any other suitable signal characteristic. Here, in block 806, the process determines whether the received signal strength is less than a threshold. If the process determines in block 806 that the signal strength is not too low, then the antenna is not blocked, and the process returns the value of block 812. If the process determines in block 806 that the signal strength is too low, then the process determines in block 808 whether the signal strength has been too low for an amount of time greater than a threshold. That is, if the signal strength were only too low for a very short length of time, then the fade is likely to be from multipath, and the orthogonal transmit diversity scheme illustrated in FIG. 5 is adequate to ensure reliable data transmission. Thus, the process returns the value of block 812 indicating that the antenna is not blocked. However, if the signal strength is determined to be less than a signal threshold for an amount of time greater than a time threshold, then the process determines that the corresponding antenna is blocked, and returns the value of block 810 indicating that the corresponding antenna is blocked.

In FIG. 8B, a process utilizing feedback from the satellite is illustrated, the feedback based on the return link (i.e., from the wireless terminal to the satellite) as measured by the satellite. In block 814, the wireless terminal receives a signal on the forward link, the forward link including a information element called a best return link antenna indicator. That is, the satellite receives the return link from the wireless terminal, the return link having the data frame as illustrated in FIG. 6, including subframes 602 and 604. Here, the satellite determines a characteristic of each of the subframes 602 and 604, for example, a signal strength, a signal to noise ratio, etc. When the satellite broadcasts the forward link intended for the wireless terminal, it includes the best return link antenna indicator, which may indicate that one of the antennas A1, A2 is blocked, and if so, which antenna is blocked. For example, the best return link antenna indicator may be a 2-bit information element, the first bit being a 0 if the signal was received acceptably from both antennas, and a 1 if one of the antennas is blocked. If one of the antennas is blocked, the second bit may be a 0 if A1 is blocked, or a 1 if A2 is blocked. Of course, any suitable other values or formats may be utilized for the return link antenna indicator. In block 816, the wireless terminal decodes the best return link antenna indicator. In block 818, the process determines if, according to the best return link antenna indicator, one of the antennas A1 or A2 is blocked. If one of the antennas is blocked, the process returns the value according to block 820; if neither antenna is blocked, the process returns the value according to block 822.

By utilizing this scheme, the satellite reception of the return signal may be improved in a case where one of the antennas is temporarily blocked.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting, from a first antenna, a first sub-packet during a first sub-frame; and
transmitting, from a second antenna spatially separated from the first antenna, a second sub-packet during a second sub-frame after the first sub-frame,
wherein the first sub-packet and the second sub-packet are portions of an encoded packet, encoded such that user information corresponding to the entire packet is independently recoverable from the first sub-packet or the second sub-packet.

2. The method of claim 1, further comprising encoding the user information with a forward error correction code having a code rate of ½ or less.

3. The method of claim 1, wherein the first antenna and the second antenna are each coupled to a switch, and the switch is coupled to a transmit chain, such that the switch enables the transmit chain to transmit from either one of the first antenna or the second antenna.

4. The method of claim 1, further comprising:
determining that one of the first antenna or the second antenna is blocked; and
transmitting, in response to the determination that one of the antennas is blocked, the first sub-packet and the second sub-packet on the other one of the first antenna or the second antenna.

5. The method of claim 4, wherein the determining that one of the first antenna or the second antenna is blocked comprises:
receiving a forward link at the first antenna;
receiving the forward link at the second antenna; and
determining that a signal strength of the one of the first antenna or the second antenna is less than a signal threshold for a length of time greater than a time threshold.

6. The method of claim 4, wherein the determining that one of the first antenna or the second antenna is blocked comprises:
receiving a forward link; and
decoding a best return link antenna indicator in the forward link, the best return link antenna indicator corresponding to a determination at a receiver that the transmission from one of the first antenna or the second antenna is blocked.

7. An apparatus for wireless communication, comprising:
means for transmitting, from a first antenna, a first sub-packet during a first sub-frame; and
means for transmitting, from a second antenna spatially separated from the first antenna, a second sub-packet during a second sub-frame after the first sub-frame,
wherein the first sub-packet and the second sub-packet are portions of an encoded packet such that user information corresponding to the entire packet is recoverable from either one of the first sub-packet or the second sub-packet.

8. The apparatus of claim 7, further comprising means for encoding the user information with a forward error correction code having a code rate of ½ or less.

9. The apparatus of claim 7, wherein the first antenna and the second antenna are each coupled to a means for switching, and the means for switching is coupled to a transmit chain, such that the means for switching enables the transmit chain to transmit from either one of the first antenna or the second antenna.

10. The apparatus of claim 7, further comprising:
means for determining that one of the first antenna or the second antenna is blocked; and
means for transmitting, in response to the determination that one of the antennas is blocked, the first sub-packet and the second sub-packet on the other one of the first antenna or the second antenna.

11. The apparatus of claim 10, wherein the means for determining that one of the first antenna or the second antenna is blocked comprises:
means for receiving a forward link at the first antenna;
means for receiving the forward link at the second antenna; and
means for determining that a signal strength of the one of the first antenna or the second antenna is less than a signal threshold for a length of time greater than a time threshold.

12. The apparatus of claim 10, wherein the means for determining that one of the first antenna or the second antenna is blocked comprises:
means for receiving a forward link; and
means for decoding a best return link antenna indicator in the forward link, the best return link antenna indicator corresponding to a determination at a receiver that the transmission from one of the first antenna or the second antenna is blocked.

13. A computer program product, comprising:
a computer-readable medium comprising code for:
transmitting, from a first antenna, a first sub-packet during a first sub-frame; and
transmitting, from a second antenna spatially separated from the first antenna, a second sub-packet during a second sub-frame after the first sub-frame,
wherein the first sub-packet and the second sub-packet are portions of an encoded packet such that user information corresponding to the entire packet is recoverable from either one of the first sub-packet or the second sub-packet.

14. The computer program product of claim 13, wherein the computer-readable medium further comprises code for encoding the user information with a forward error correction code having a code rate of ½ or less.

15. The computer program product of claim 13, wherein the first antenna and the second antenna are each coupled to a switch, and the switch is coupled to a transmit chain, such that the switch enables the transmit chain to transmit from either one of the first antenna or the second antenna.

16. The computer program product of claim 13, wherein the computer-readable medium further comprises code for:
determining that one of the first antenna or the second antenna is blocked; and
transmitting, in response to the determination that one of the antennas is blocked, the first sub-packet and the second sub-packet on the other one of the first antenna or the second antenna.

17. The computer program product of claim 16, wherein the code for determining that one of the first antenna or the second antenna is blocked comprises:
code for receiving a forward link at the first antenna;
code for receiving the forward link at the second antenna; and
code for determining that a signal strength of the one of the first antenna or the second antenna is less than a signal threshold for a length of time greater than a time threshold.

18. The computer program product of claim 16, wherein the code for determining that one of the first antenna or the second antenna is blocked comprises:
code for receiving a forward link; and
code for decoding a best return link antenna indicator in the forward link, the best return link antenna indicator corresponding to a determination at a receiver that the transmission from one of the first antenna or the second antenna is blocked.

19. An apparatus for wireless communication, comprising:
at least one processor; and
a memory coupled to the at least one processor,
wherein the at least one processor is configured to:
transmit, from a first antenna, a first sub-packet during a first sub-frame; and
transmit, from a second antenna spatially separated from the first antenna, a second sub-packet during a second sub-frame after the first sub-frame,
wherein the first sub-packet and the second sub-packet are portions of an encoded packet such that user information corresponding to the entire packet is recoverable from either one of the first sub-packet or the second sub-packet.

20. The apparatus of claim 19, wherein the at least one processor is further configured to encode the user information with a forward error correction code having a code rate of ½ or less.

21. The apparatus of claim 19, wherein the first antenna and the second antenna are each coupled to a switch, and the switch is coupled to a transmit chain, such that the switch enables the transmit chain to transmit from either one of the first antenna or the second antenna.

22. The apparatus of claim 19, wherein the at least one processor is further configured to:
determine that one of the first antenna or the second antenna is blocked; and
transmit, in response to the determination that one of the antennas is blocked, the first sub-packet and the second sub-packet on the other one of the first antenna or the second antenna.

23. The apparatus of claim 22, wherein the determining that one of the first antenna or the second antenna is blocked comprises:
receiving a forward link at the first antenna;
receiving the forward link at the second antenna; and
determining that a signal strength of the one of the first antenna or the second antenna is less than a signal threshold for a length of time greater than a time threshold.

24. The apparatus of claim 22, wherein the determining that one of the first antenna or the second antenna is blocked comprises:
receiving a forward link; and
decoding a best return link antenna indicator in the forward link, the best return link antenna indicator corresponding to a determination at a receiver that the transmission from one of the first antenna or the second antenna is blocked.

25. A transmitter module, comprising:
a plurality of spatially separated antennas;
a switch coupled to each of the plurality of spatially separated antennas, the switch for sequentially selecting one of the plurality of spatially separated antennas during a corresponding sub-frame of a data frame,
wherein, each sub-frame is adapted for transmission of a respective portion of an encoded information packet, encoded such that the entire information packet is recoverable from any one of the sub-frames.
